(19) United States
(12) Patent Application Publication
(10) Pub. No.: US 2026/0288972 A1
(43) Pub. Date: Sep. 24, 2026

(54) Method, System, and Computer Program Product for Multi-Layer Analysis and Detection of Vulnerability of Machine Learning Models to Adversarial Attacks

(71) Applicant: VISA INTERNATIONAL SERVICE ASSOCIATION, San Francisco, CA (US)

(72) Inventors: Miaomiao Liu, Merced, CA (US); Nicholas Stephen Kersting, Austin, TX (US); Runxin He, Cedar Park, TX (US); Yu Gu, Austin, TX (US)

(21) Appl. No.: 19/477,128

(22) PCT Filed: Apr. 19, 2024
(86) PCT No.: PCT/US2024/025383

§ 371 Date: Oct. 21, 2025

Related U.S. Application Data
(60) Provisional application No. 63/497,543, filed on Apr. 21, 2023.

(51) Int. Cl. G06F 21/57

(52) U.S. Cl. CPC G06F 21/577; G06F 2221/033

(57) ABSTRACT

Methods, systems, and computer program products are provided for multi-layer analysis and detection of vulnerability of machine learning models to adversarial attacks. An example method includes selecting a sample, inputting the sample to a machine learning model, perturbing the sample to generate perturbed samples, inputting each respective perturbed sample to the machine learning model, and determining a smallest perturbation distance for the input layer. For each respective hidden layer of the machine learning model, a respective hidden layer representation of the sample is perturbed to generate perturbed hidden layer representations. Each respective perturbed hidden layer representation is inputted to the machine learning model, and a respective smallest perturbation distance for each respective hidden layer is determined. At least one vulnerability metric is determined based on the smallest perturbation distance for the input layer and the hidden layer(s). The machine learning model is retrained based on the vulnerability metric(s).

### CROSS REFERENCE TO RELATED APPLICATIONS

This application is the United States national phase of International Application No. PCT/US24/25383 filed Apr. 19, 2024, and claims priority to U.S. Provisional Patent Application No. 63/497,543, filed Apr. 21, 2023, the disclosures of which are hereby incorporated by reference in their entireties.

### BACKGROUND

### 1. Technical Field

This disclosure relates generally to adversarial analysis of machine learning models and, in some non-limiting embodiments or aspects, to methods, systems, and computer program products for multi-layer analysis and detection of vulnerability of machine learning models to adversarial attacks.

### 2. Technical Considerations

Machine learning models (e.g., deep learning models) are highly vulnerable to adversarial inputs. An adversarial input may include an input created with a small but intentional perturbation from authentic input data so that the machine learning model misclassifies the adversarial input (e.g., with high confidence). For example, adversarial inputs may be created for a malicious purpose, e.g., to attack the machine learning model and/or to trick the machine learning model into misclassifying the input.

Adversarial analysis may help to improve the robustness of a machine learning model. However, certain techniques for adversarial analysis are unsatisfactory. For example, it may be difficult to effectively summarize adversarial weaknesses in an entire input space. Certain techniques for adversarial analysis include perturbing around a set of input points in the input space to measure adversarial distance, but it is challenging to determine whether the input points are sufficient to represent the input space. To be completely confident that the machine learning model is robust, it would be necessary to scan all of the input space, which may be impossible because the input space may be infinite. In addition, randomness and/or computational errors can arise in deep machine learning models (e.g., hidden layers of deep neural networks and/or the like), and simply measuring adversarial distance in the input space does not accurately reflect these phenomena in all of the layers of such models.

### SUMMARY

Accordingly, provided are improved methods, systems, and computer program products for multi-layer analysis and detection of vulnerability of machine learning models to adversarial attacks (e.g., that overcome some or all of the deficiencies identified above).

According to non-limiting embodiments or aspects, provided is a computer-implemented method for multi-layer analysis and detection of vulnerability of machine learning models to adversarial attacks. An example method may include selecting a sample of a plurality of samples of a dataset. The sample may be inputted to a machine learning model to generate at least one intermediate output and a final output. The machine learning model may include a plurality of layers including an input layer, at least one hidden layer, and an output layer. Each intermediate output of the at least one intermediate output may include an output between successive layers of the plurality of layers. The final output may include an output of the output layer. The sample may be perturbed to generate a plurality of perturbed samples. Each respective perturbed sample of the plurality of perturbed samples may have a respective distance from the sample. Each respective perturbed sample of the plurality of perturbed samples may be inputted to the machine learning model to generate a respective perturbed output. A subset of the plurality of perturbed samples for which the respective perturbed output differs from the final output may be determined. A smallest perturbation distance for the input layer may be determined based on the respective distance of each respective perturbed sample of the subset of the plurality of perturbed samples. For each respective hidden layer of the at least one hidden layer, a respective hidden layer representation of the sample may be perturbed to generate a plurality of perturbed hidden layer representations. Each respective perturbed hidden layer representation may have a further respective distance from the respective hidden layer representation of the sample. Each respective perturbed hidden layer representation may be inputted to the machine learning model to generate a further respective perturbed output. A subset of the plurality of perturbed hidden layer representations for which the further respective perturbed output differs from the final output may be determined. A respective smallest perturbation distance for the respective hidden layer may be determined based on the further respective distance of each respective perturbed hidden layer representation of the subset of the plurality of perturbed hidden layer representations. At least one vulnerability metric may be determined based on the smallest perturbation distance for the input layer and the respective smallest perturbation distance for each respective hidden layer.

In some non-limiting embodiments or aspects, the machine learning model may be retrained based on the at least one vulnerability metric.

In some non-limiting embodiments or aspects, the sample may include a selected sample. The method further may include selecting a different sample of the plurality of samples of the dataset at the selected sample. The method further may include repeating the inputting of the selected sample to the machine learning model, the perturbing of the selected sample, the inputting of each respective perturbed sample to the machine learning model, the determining of the subset of the plurality of perturbed samples, the determining of the smallest perturbation distance for the input layer, the perturbing of the respective hidden layer representation of the selected sample for each respective hidden layer of the at least one hidden layer, the inputting of each respective perturbed hidden layer representation to the machine learning model for each respective hidden layer of the at least one hidden layer, the determining of the subset of the plurality of perturbed hidden layer representations for each respective hidden layer of the at least one hidden layer, the determining of the respective smallest perturbation distance for the respective hidden layer for each respective hidden layer of the at least one hidden layer, and the determining of the at least one vulnerability metric.

In some non-limiting embodiments or aspects, the method further may include perturbing an output layer representation of the sample to generate a plurality of perturbed output layer representations. Each respective perturbed output layer representation having a respective distance from the respective output layer representation of the sample. Each respective perturbed output layer representation may be inputted to the machine learning model to generate a respective perturbed output. A subset of the plurality of perturbed output layer representations for which the respective perturbed output differs from the final output may be determined. A smallest perturbation distance for the output layer may be determined based on the respective distance of each respective perturbed output layer representation of the subset of the plurality of perturbed output layer representations. Determining the at least one vulnerability metric may include determining the at least one vulnerability metric based on the smallest perturbation distance for the input layer, the respective smallest perturbation distance for each respective hidden layer, and the smallest perturbation distance for the output layer.

In some non-limiting embodiments or aspects, the at least one vulnerability metric may include at least one of a harmonic mean or a weighted summation.

In some non-limiting embodiments or aspects, each respective distance may include a respective Euclidean distance.

In some non-limiting embodiments or aspects, retraining the machine learning model based on the at least one vulnerability metric may include tracing features of at least one perturbed hidden layer representation of the plurality of perturbed hidden layer representations to the input layer, determining a volume of an input space based on tracing the features of the at least one perturbed hidden layer representation, and/or retraining the machine learning model based on a plurality of new samples in the volume of the input space.

In some non-limiting embodiments or aspects, selecting the sample may include randomly selecting the sample from the plurality of samples.

According to non-limiting embodiments or aspects, provided is a system for multi-layer analysis and detection of vulnerability of machine learning models to adversarial attacks. An example system may include at least one processor and at least one non-transitory computer-readable medium storing instructions that, when executed by the at least one processor, cause the at least one processor to select a sample of a plurality of samples of a dataset. The instructions, when executed by the at least one processor, may further cause the at least one processor to input the sample to a machine learning model to generate at least one intermediate output and a final output. The machine learning model may include a plurality of layers including an input layer, at least one hidden layer, and an output layer. Each intermediate output of the at least one intermediate output may include an output between successive layers of the plurality of layers. The final output may include an output of the output layer. The instructions, when executed by the at least one processor, may further cause the at least one processor to perturb the sample to generate a plurality of perturbed samples. Each respective perturbed sample of the plurality of perturbed samples may have a respective distance from the sample. The instructions, when executed by the at least one processor, may further cause the at least one processor to input each respective perturbed sample of the plurality of perturbed samples to the machine learning model to generate a respective perturbed output. The instructions, when executed by the at least one processor, may further cause the at least one processor to determine a subset of the plurality of perturbed samples for which the respective perturbed output differs from the final output. The instructions, when executed by the at least one processor, may further cause the at least one processor to determine a smallest perturbation distance for the input layer based on the respective distance of each respective perturbed sample of the subset of the plurality of perturbed samples. For each respective hidden layer of the at least one hidden layer, the instructions, when executed by the at least one processor, may further cause the at least one processor to perturb a respective hidden layer representation of the sample to generate a plurality of perturbed hidden layer representations. Each respective perturbed hidden layer representation may have a further respective distance from the respective hidden layer representation of the sample. The instructions, when executed by the at least one processor, may further cause the at least one processor to input each respective perturbed hidden layer representation to the machine learning model to generate a further respective perturbed output. The instructions, when executed by the at least one processor, may further cause the at least one processor to determine a subset of the plurality of perturbed hidden layer representations for which the further respective perturbed output differs from the final output. The instructions, when executed by the at least one processor, may further cause the at least one processor to determine a respective smallest perturbation distance for the respective hidden layer based on the further respective distance of each respective perturbed hidden layer representation of the subset of the plurality of perturbed hidden layer representations. The instructions, when executed by the at least one processor, may further cause the at least one processor to determine at least one vulnerability metric based on the smallest perturbation distance for the input layer and the respective smallest perturbation distance for each respective hidden layer.

In some non-limiting embodiments or aspects, the instructions, when executed by the at least one processor, may further cause the at least one processor to retrain the machine learning model based on the at least one vulnerability metric.

In some non-limiting embodiments or aspects, the sample may include a selected sample. The instructions, when executed by the at least one processor, may further cause the at least one processor to select a different sample of the plurality of samples of the dataset at the selected sample. The instructions, when executed by the at least one processor, may further cause the at least one processor to repeat the inputting of the selected sample to the machine learning model, the perturbing of the selected sample, the inputting of each respective perturbed sample to the machine learning model, the determining of the subset of the plurality of perturbed samples, the determining of the smallest perturbation distance for the input layer, the perturbing of the respective hidden layer representation of the selected sample for each respective hidden layer of the at least one hidden layer, the inputting of each respective perturbed hidden layer representation to the machine learning model for each respective hidden layer of the at least one hidden layer, the determining of the subset of the plurality of perturbed hidden layer representations for each respective hidden layer of the at least one hidden layer, the determining of the respective smallest perturbation distance for the respective hidden layer for each respective hidden layer of the at least one hidden layer, and the determining of the at least one vulnerability metric.

In some non-limiting embodiments or aspects, the instructions, when executed by the at least one processor, may further cause the at least one processor to perturb an output layer representation of the sample to generate a plurality of perturbed output layer representations. Each respective perturbed output layer representation having a respective distance from the respective output layer representation of the sample. The instructions, when executed by the at least one processor, may further cause the at least one processor to input each respective perturbed output layer representation to the machine learning model to generate a respective perturbed output. The instructions, when executed by the at least one processor, may further cause the at least one processor to determine a subset of the plurality of perturbed output layer representations for which the respective perturbed output differs from the final output. The instructions, when executed by the at least one processor, may further cause the at least one processor to determine a smallest perturbation distance for the output layer based on the respective distance of each respective perturbed output layer representation of the subset of the plurality of perturbed output layer representations. Determining the at least one vulnerability metric may include determining the at least one vulnerability metric based on the smallest perturbation distance for the input layer, the respective smallest perturbation distance for each respective hidden layer, and the smallest perturbation distance for the output layer.

In some non-limiting embodiments or aspects, the at least one vulnerability metric may include at least one of a harmonic mean or a weighted summation.

In some non-limiting embodiments or aspects, each respective distance may include a respective Euclidean distance.

In some non-limiting embodiments or aspects, retraining the machine learning model based on the at least one vulnerability metric may include tracing features of at least one perturbed hidden layer representation of the plurality of perturbed hidden layer representations to the input layer, determining a volume of an input space based on tracing the features of the at least one perturbed hidden layer representation, and/or retraining the machine learning model based on a plurality of new samples in the volume of the input space.

In some non-limiting embodiments or aspects, selecting the sample may include randomly selecting the sample from the plurality of samples.

According to non-limiting embodiments or aspects, provided is a computer program product for multi-layer analysis and detection of vulnerability of machine learning models to adversarial attacks. An example computer program product may include at least one non-transitory computer-readable medium including program instructions that, when executed by at least one processor, cause the at least one processor to select a sample of a plurality of samples of a dataset. The instructions, when executed by the at least one processor, may further cause the at least one processor to input the sample to a machine learning model to generate at least one intermediate output and a final output.

The machine learning model may include a plurality of layers including an input layer, at least one hidden layer, and an output layer. Each intermediate output of the at least one intermediate output may include an output between successive layers of the plurality of layers. The final output may include an output of the output layer. The instructions, when executed by the at least one processor, may further cause the at least one processor to perturb the sample to generate a plurality of perturbed samples. Each respective perturbed sample of the plurality of perturbed samples may have a respective distance from the sample. The instructions, when executed by the at least one processor, may further cause the at least one processor to input each respective perturbed sample of the plurality of perturbed samples to the machine learning model to generate a respective perturbed output. The instructions, when executed by the at least one processor, may further cause the at least one processor to determine a subset of the plurality of perturbed samples for which the respective perturbed output differs from the final output. The instructions, when executed by the at least one processor, may further cause the at least one processor to determine a smallest perturbation distance for the input layer based on the respective distance of each respective perturbed sample of the subset of the plurality of perturbed samples. For each respective hidden layer of the at least one hidden layer, the instructions, when executed by the at least one processor, may further cause the at least one processor to perturb a respective hidden layer representation of the sample to generate a plurality of perturbed hidden layer representations. Each respective perturbed hidden layer representation may have a further respective distance from the respective hidden layer representation of the sample. The instructions, when executed by the at least one processor, may further cause the at least one processor to input each respective perturbed hidden layer representation to the machine learning model to generate a further respective perturbed output. The instructions, when executed by the at least one processor, may further cause the at least one processor to determine a subset of the plurality of perturbed hidden layer representations for which the further respective perturbed output differs from the final output. The instructions, when executed by the at least one processor, may further cause the at least one processor to determine a respective smallest perturbation distance for the respective hidden layer based on the further respective distance of each respective perturbed hidden layer representation of the subset of the plurality of perturbed hidden layer representations. The instructions, when executed by the at least one processor, may further cause the at least one processor to determine at least one vulnerability metric based on the smallest perturbation distance for the input layer and the respective smallest perturbation distance for each respective hidden layer.

In some non-limiting embodiments or aspects, the instructions, when executed by the at least one processor, may further cause the at least one processor to retrain the machine learning model based on the at least one vulnerability metric.

In some non-limiting embodiments or aspects, the sample may include a selected sample. The instructions, when executed by the at least one processor, may further cause the at least one processor to select a different sample of the plurality of samples of the dataset at the selected sample. The instructions, when executed by the at least one processor, may further cause the at least one processor to repeat the inputting of the selected sample to the machine learning model, the perturbing of the selected sample, the inputting of each respective perturbed sample to the machine learning model, the determining of the subset of the plurality of perturbed samples, the determining of the smallest perturbation distance for the input layer, the perturbing of the respective hidden layer representation of the selected sample for each respective hidden layer of the at least one hidden layer, the inputting of each respective perturbed hidden layer representation to the machine learning model for each respective hidden layer of the at least one hidden layer, the determining of the subset of the plurality of perturbed hidden layer representations for each respective hidden layer of the at least one hidden layer, the determining of the respective smallest perturbation distance for the respective hidden layer for each respective hidden layer of the at least one hidden layer, and the determining of the at least one vulnerability metric.

In some non-limiting embodiments or aspects, the instructions, when executed by the at least one processor, may further cause the at least one processor to perturb an output layer representation of the sample to generate a plurality of perturbed output layer representations. Each respective perturbed output layer representation having a respective distance from the respective output layer representation of the sample. The instructions, when executed by the at least one processor, may further cause the at least one processor to input each respective perturbed output layer representation to the machine learning model to generate a respective perturbed output. The instructions, when executed by the at least one processor, may further cause the at least one processor to determine a subset of the plurality of perturbed output layer representations for which the respective perturbed output differs from the final output. The instructions, when executed by the at least one processor, may further cause the at least one processor to determine a smallest perturbation distance for the output layer based on the respective distance of each respective perturbed output layer representation of the subset of the plurality of perturbed output layer representations. Determining the at least one vulnerability metric may include determining the at least one vulnerability metric based on the smallest perturbation distance for the input layer, the respective smallest perturbation distance for each respective hidden layer, and the smallest perturbation distance for the output layer.

In some non-limiting embodiments or aspects, the at least one vulnerability metric may include at least one of a harmonic mean or a weighted summation.

In some non-limiting embodiments or aspects, each respective distance may include a respective Euclidean distance.

In some non-limiting embodiments or aspects, retraining the machine learning model based on the at least one vulnerability metric may include tracing features of at least one perturbed hidden layer representation of the plurality of perturbed hidden layer representations to the input layer, determining a volume of an input space based on tracing the features of the at least one perturbed hidden layer representation, and/or retraining the machine learning model based on a plurality of new samples in the volume of the input space.

In some non-limiting embodiments or aspects, selecting the sample may include randomly selecting the sample from the plurality of samples.

Further non-limiting embodiments or aspects will be set forth in the following numbered clauses:
Clause 1: A computer-implemented method, comprising: selecting, with at least one processor, a sample of a plurality of samples of a dataset; inputting, with at least one processor, the sample to a machine learning model to generate at least one intermediate output and a final output, the machine learning model comprising a plurality of layers including an input layer, at least one hidden layer, and an output layer, each intermediate output of the at least one intermediate output comprising an output between successive layers of the plurality of layers, the final output comprising an output of the output layer; perturbing, with at least one processor, the sample to generate a plurality of perturbed samples, each respective perturbed sample of the plurality of perturbed samples having a respective distance from the sample; inputting, with at least one processor, each respective perturbed sample of the plurality of perturbed samples to the machine learning model to generate a respective perturbed output; determining, with at least one processor, a subset of the plurality of perturbed samples for which the respective perturbed output differs from the final output; determining, with at least one processor, a smallest perturbation distance for the input layer based on the respective distance of each respective perturbed sample of the subset of the plurality of perturbed samples; for each respective hidden layer of the at least one hidden layer: perturbing, with at least one processor, a respective hidden layer representation of the sample to generate a plurality of perturbed hidden layer representations, each respective perturbed hidden layer representation having a further respective distance from the respective hidden layer representation of the sample; inputting, with at least one processor, each respective perturbed hidden layer representation to the machine learning model to generate a further respective perturbed output; determining, with at least one processor, a subset of the plurality of perturbed hidden layer representations for which the further respective perturbed output differs from the final output; and determining, with at least one processor, a respective smallest perturbation distance for the respective hidden layer based on the further respective distance of each respective perturbed hidden layer representation of the subset of the plurality of perturbed hidden layer representations; determining, with at least one processor, at least one vulnerability metric based on the smallest perturbation distance for the input layer and the respective smallest perturbation distance for each respective hidden layer; and retraining, with at least one processor, the machine learning model based on the at least one vulnerability metric.
Clause 2: The method of clause 1, wherein the sample comprises a selected sample, the method further comprising: selecting, with at least one processor, a different sample of the plurality of samples of the dataset at the selected sample; repeating the inputting of the selected sample to the machine learning model, the perturbing of the selected sample, the inputting of each respective perturbed sample to the machine learning model, the determining of the subset of the plurality of perturbed samples, the determining of the smallest perturbation distance for the input layer, the perturbing of the respective hidden layer representation of the selected sample for each respective hidden layer of the at least one hidden layer, the inputting of each respective perturbed hidden layer representation to the machine learning model for each respective hidden layer of the at least one hidden layer, the determining of the subset of the plurality of perturbed hidden layer representations for each respective hidden layer of the at least one hidden layer, the determining of the respective smallest perturbation distance for the respective hidden layer for each respective hidden layer of the at least one hidden layer, and the determining of the at least one vulnerability metric.
Clause 3: The method of clause 1 or clause 2, further comprising: perturbing, with at least one processor, an output layer representation of the sample to generate a plurality of perturbed output layer representations, each respective perturbed output layer representation having a respective distance from the respective output layer representation of the sample; inputting, with at least one processor, each respective perturbed output layer representation to the machine learning model to generate a respective perturbed output; determining, with at least one processor, a subset of the plurality of perturbed output layer representations for which the respective perturbed output differs from the final output; and determining, with at least one processor, a smallest perturbation distance for the output layer based on the respective distance of each respective perturbed output layer representation of the subset of the plurality of perturbed output layer representations, wherein determining the at least one vulnerability metric comprises determining the at least one vulnerability metric based on the smallest perturbation distance for the input layer, the respective smallest perturbation distance for each respective hidden layer, and the smallest perturbation distance for the output layer.
Clause 4: The method of any of clauses 1-3, wherein the at least one vulnerability metric comprises at least one of a harmonic mean or a weighted summation.
Clause 5: The method of any of clauses 1-4, wherein each respective distance comprises a respective Euclidean distance.
Clause 6: The method of any of clauses 1-5, wherein retraining the machine learning model based on the at least one vulnerability metric comprises: tracing features of at least one perturbed hidden layer representation of the plurality of perturbed hidden layer representations to the input layer; determining a volume of an input space based on tracing the features of the at least one perturbed hidden layer representation; and retraining the machine learning model based on a plurality of new samples in the volume of the input space.
Clause 7: The method of any of clauses 1-6, wherein selecting the sample comprises randomly selecting the sample from the plurality of samples.
Clause 8: A system, comprising: at least one processor; and at least one non-transitory computer-readable medium storing instructions that, when executed by the at least one processor, cause the at least one processor to: select a sample of a plurality of samples of a dataset; input the sample to a machine learning model to generate at least one intermediate output and a final output, the machine learning model comprising a plurality of layers including an input layer, at least one hidden layer, and an output layer, each intermediate output of the at least one intermediate output comprising an output between successive layers of the plurality of layers, the final output comprising an output of the output layer; perturb the sample to generate a plurality of perturbed samples, each respective perturbed sample of the plurality of perturbed samples having a respective distance from the sample; input each respective perturbed sample of the plurality of perturbed samples to the machine learning model to generate a respective perturbed output; determine a subset of the plurality of perturbed samples for which the respective perturbed output differs from the final output; determine a smallest perturbation distance for the input layer based on the respective distance of each respective perturbed sample of the subset of the plurality of perturbed samples; for each respective hidden layer of the at least one hidden layer: perturb a respective hidden layer representation of the sample to generate a plurality of perturbed hidden layer representations, each respective perturbed hidden layer representation having a further respective distance from the respective hidden layer representation of the sample; input each respective perturbed hidden layer representation to the machine learning model to generate a further respective perturbed output; determine a subset of the plurality of perturbed hidden layer representations for which the further respective perturbed output differs from the final output; and determine a respective smallest perturbation distance for the respective hidden layer based on the further respective distance of each respective perturbed hidden layer representation of the subset of the plurality of perturbed hidden layer representations; determine at least one vulnerability metric based on the smallest perturbation distance for the input layer and the respective smallest perturbation distance for each respective hidden layer; and retrain the machine learning model based on the at least one vulnerability metric.
Clause 9: The system of clause 8, wherein the sample comprises a selected sample, and wherein the instructions, when executed by the at least one processor, further cause the at least one processor to: select a different sample of the plurality of samples of the dataset at the selected sample; repeat the inputting of the selected sample to the machine learning model, the perturbing of the selected sample, the inputting of each respective perturbed sample to the machine learning model, the determining of the subset of the plurality of perturbed samples, the determining of the smallest perturbation distance for the input layer, the perturbing of the respective hidden layer representation of the selected sample for each respective hidden layer of the at least one hidden layer, the inputting of each respective perturbed hidden layer representation to the machine learning model for each respective hidden layer of the at least one hidden layer, the determining of the subset of the plurality of perturbed hidden layer representations for each respective hidden layer of the at least one hidden layer, the determining of the respective smallest perturbation distance for the respective hidden layer for each respective hidden layer of the at least one hidden layer, and the determining of the at least one vulnerability metric.
Clause 10: The system of clause 8 or clause 9, wherein the instructions, when executed by the at least one processor, further cause the at least one processor to: perturb an output layer representation of the sample to generate a plurality of perturbed output layer representations, each respective perturbed output layer representation having a respective distance from the respective output layer representation of the sample; input each respective perturbed output layer representation to the machine learning model to generate a respective perturbed output; determine a subset of the plurality of perturbed output layer representations for which the respective perturbed output differs from the final output; and determine a smallest perturbation distance for the output layer based on the respective distance of each respective perturbed output layer representation of the subset of the plurality of perturbed output layer representations, wherein determining the at least one vulnerability metric comprises determining the at least one vulnerability metric based on the smallest perturbation distance for the input layer, the respective smallest perturbation distance for each respective hidden layer, and the smallest perturbation distance for the output layer.
Clause 11: The system of any of clauses 8-10, wherein the at least one vulnerability metric comprises at least one of a harmonic mean or a weighted summation.
Clause 12: The system of any of clauses 8-11, wherein each respective distance comprises a respective Euclidean distance.
Clause 13: The system of any of clauses 8-12, wherein retraining the machine learning model based on the at least one vulnerability metric comprises: tracing features of at least one perturbed hidden layer representation of the plurality of perturbed hidden layer representations to the input layer; determining a volume of an input space based on tracing the features of the at least one perturbed hidden layer representation; and retraining the machine learning model based on a plurality of new samples in the volume of the input space.
Clause 14: The system of any of clauses 8-13, wherein selecting the sample comprises randomly selecting the sample from the plurality of samples.
Clause 15: A computer program product comprising at least one non-transitory computer-readable medium including program instructions that, when executed by at least one processor, cause the at least one processor to: select a sample of a plurality of samples of a dataset; input the sample to a machine learning model to generate at least one intermediate output and a final output, the machine learning model comprising a plurality of layers including an input layer, at least one hidden layer, and an output layer, each intermediate output of the at least one intermediate output comprising an output between successive layers of the plurality of layers, the final output comprising an output of the output layer; perturb the sample to generate a plurality of perturbed samples, each respective perturbed sample of the plurality of perturbed samples having a respective distance from the sample; input each respective perturbed sample of the plurality of perturbed samples to the machine learning model to generate a respective perturbed output; determine a subset of the plurality of perturbed samples for which the respective perturbed output differs from the final output; determine a smallest perturbation distance for the input layer based on the respective distance of each respective perturbed sample of the subset of the plurality of perturbed samples; for each respective hidden layer of the at least one hidden layer: perturb a respective hidden layer representation of the sample to generate a plurality of perturbed hidden layer representations, each respective perturbed hidden layer representation having a further respective distance from the respective hidden layer representation of the sample; input each respective perturbed hidden layer representation to the machine learning model to generate a further respective perturbed output; determine a subset of the plurality of perturbed hidden layer representations for which the further respective perturbed output differs from the final output; and determine a respective smallest perturbation distance for the respective hidden layer based on the further respective distance of each respective perturbed hidden layer representation of the subset of the plurality of perturbed hidden layer representations; determine at least one vulnerability metric based on the smallest perturbation distance for the input layer and the respective smallest perturbation distance for each respective hidden layer; and retrain the machine learning model based on the at least one vulnerability metric.
Clause 16: The computer program product of clause 15, wherein the sample comprises a selected sample, and wherein the instructions, when executed by the at least one processor, further cause the at least one processor to: select a different sample of the plurality of samples of the dataset at the selected sample; repeat the inputting of the selected sample to the machine learning model, the perturbing of the selected sample, the inputting of each respective perturbed sample to the machine learning model, the determining of the subset of the plurality of perturbed samples, the determining of the smallest perturbation distance for the input layer, the perturbing of the respective hidden layer representation of the selected sample for each respective hidden layer of the at least one hidden layer, the inputting of each respective perturbed hidden layer representation to the machine learning model for each respective hidden layer of the at least one hidden layer, the determining of the subset of the plurality of perturbed hidden layer representations for each respective hidden layer of the at least one hidden layer, the determining of the respective smallest perturbation distance for the respective hidden layer for each respective hidden layer of the at least one hidden layer, and the determining of the at least one vulnerability metric.
Clause 17: The computer program product of clause 15 or clause 16, wherein the instructions, when executed by the at least one processor, further cause the at least one processor to: perturb an output layer representation of the sample to generate a plurality of perturbed output layer representations, each respective perturbed output layer representation having a respective distance from the respective output layer representation of the sample; input each respective perturbed output layer representation to the machine learning model to generate a respective perturbed output; determine a subset of the plurality of perturbed output layer representations for which the respective perturbed output differs from the final output; and determine a smallest perturbation distance for the output layer based on the respective distance of each respective perturbed output layer representation of the subset of the plurality of perturbed output layer representations, wherein determining the at least one vulnerability metric comprises determining the at least one vulnerability metric based on the smallest perturbation distance for the input layer, the respective smallest perturbation distance for each respective hidden layer, and the smallest perturbation distance for the output layer.
Clause 18: The computer program product of any of clauses 15-17, wherein the at least one vulnerability metric comprises at least one of a harmonic mean or a weighted summation.
Clause 19: The computer program product of any of clauses 15-18, wherein each respective distance comprises a respective Euclidean distance.
Clause 20: The computer program product of any of clauses 15-19, wherein retraining the machine learning model based on the at least one vulnerability metric comprises: tracing features of at least one perturbed hidden layer representation of the plurality of perturbed hidden layer representations to the input layer; determining a volume of an input space based on tracing the features of the at least one perturbed hidden layer representation; and retraining the machine learning model based on a plurality of new samples in the volume of the input space.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of an example system for multi-layer analysis and detection of vulnerability of machine learning models to adversarial attacks, according to some non-limiting embodiments or aspects;

FIG. 2 is a flow diagram for an example process for multi-layer analysis and detection of vulnerability of machine learning models to adversarial attacks, according to some non-limiting embodiments or aspects;

FIGS. 3A-3D are diagrams of an example implementation of a process for multi-layer analysis and detection of vulnerability of machine learning models to adversarial attacks, according to some non-limiting embodiments or aspects;

FIG. 4 is a schematic diagram of an example implementation of a system for multi-layer analysis and detection of vulnerability of machine learning models to adversarial attacks, according to some non-limiting embodiments or aspects;

FIG. 5 is a diagram of an example environment in which methods, systems, and/or computer program products, described herein, may be implemented, according to some non-limiting embodiments or aspects;

FIG. 6 is a schematic diagram of example components of a device used in connection with some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects of the disclosed subject matter. Hence, specific dimensions and other physical characteristics related to the embodiments or aspects disclosed herein are not to be considered as limiting.

Some non-limiting embodiments or aspects may be described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes.

As used herein, the term “acquirer institution” may refer to an entity licensed and/or approved by a transaction service provider to originate transactions (e.g., payment transactions) using a payment device associated with the transaction service provider. The transactions the acquirer institution may originate may include payment transactions (e.g., purchases, original credit transactions (OCTs), account funding transactions (AFTs), and/or the like). In some non-limiting embodiments or aspects, an acquirer institution may be a financial institution, such as a bank. As used herein, the term “acquirer system” may refer to one or more computing devices operated by or on behalf of an acquirer institution, such as a server computer executing one or more software applications.

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the terms “electronic wallet” and “electronic wallet application” refer to one or more electronic devices and/or software applications configured to initiate and/or conduct payment transactions. For example, an electronic wallet may include a mobile device executing an electronic wallet application, and may further include server-side software and/or databases for maintaining and providing transaction data to the mobile device. An “electronic wallet provider” may include an entity that provides and/or maintains an electronic wallet for a customer, such as Google Pay®, Android Pay®, Apple Pay®, Samsung Pay®, and/or other like electronic payment systems. In some non-limiting examples, an issuer bank may be an electronic wallet provider.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a primary account number (PAN), to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer devices operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications.

As used herein, a “point-of-sale (POS) device” may refer to one or more devices, which may be used by a merchant to conduct a transaction (e.g., a payment transaction) and/or process a transaction. For example, a POS device may include one or more client devices. Additionally or alternatively, a POS device may include peripheral devices, card readers, scanning devices (e.g., code scanners), Bluetooth® communication receivers, near-field communication (NFC) receivers, radio frequency identification (RFID) receivers, and/or other contactless transceivers or receivers, contact-based receivers, payment terminals, and/or the like. As used herein, a “point-of-sale (POS) system” may refer to one or more client devices and/or peripheral devices used by a merchant to conduct a transaction. For example, a POS system may include one or more POS devices and/or other like devices that may be used to conduct a payment transaction. In some non-limiting embodiments or aspects, a POS system (e.g., a merchant POS system) may include one or more server computers configured to process online payment transactions through webpages, mobile applications, and/or the like.

As used herein, the terms “client” and/or “client device” may refer to one or more client-side devices or systems (e.g., remote from a transaction service provider system) used to initiate or facilitate a transaction (e.g., a payment transaction). As an example, a “client device” may refer to one or more POS devices used by a merchant, one or more acquirer host computers used by an acquirer, one or more mobile devices used by a user, and/or the like. In some non-limiting embodiments or aspects, a client device may be an electronic device configured to communicate with one or more networks and initiate or facilitate transactions. For example, a client device may include one or more computers, portable computers, laptop computers, tablet computers, mobile devices, cellular phones, wearable devices (e.g., watches, glasses, lenses, clothing, and/or the like), PDAs, and/or the like. Moreover, a “client” may also refer to an entity (e.g., a merchant, an acquirer, and/or the like) that owns, utilizes, and/or operates a client device for initiating transactions (e.g., for initiating transactions with a transaction service provider).

As used herein, the term “payment device” may refer to an electronic payment device, a portable financial device, a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a personal digital assistant (PDA), a pager, a security card, a computing device, an access card, a wireless terminal, a transponder, and/or the like. In some non-limiting embodiments or aspects, the payment device may include volatile or non-volatile memory to store information (e.g., an account identifier, a name of the account holder, and/or the like).

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like, operated by or on behalf of a payment gateway.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

Non-limiting embodiments or aspects of the disclosed subject matter are directed to methods, systems, and computer program products for adversarial analysis of machine learning models including, but not limited to, multi-layer analysis and detection of vulnerability of machine learning models to adversarial attacks. For example, non-limiting embodiments or aspects of the disclosed subject matter provide selecting a sample from a dataset, inputting the sample to a machine learning model (e.g., having a plurality of layers including an input layer, at least one hidden layer, and an output layer) to generate at least one intermediate output (e.g., an output between successive layers of the plurality of layers) and a final output (e.g., an output of the output layer), perturbing the sample to generate a plurality of perturbed samples, inputting each respective perturbed sample of the plurality of perturbed samples to the machine learning model to generate a respective perturbed output, determining a subset of the plurality of perturbed samples for which the respective perturbed output differs from the final output, and determining a smallest perturbation distance for the input layer based on the respective distance of each respective perturbed sample of the subset. Additionally, such embodiments or aspects of the disclosed subject matter provide, for each respective hidden layer (and/or the output layer), perturbing a respective hidden layer representation of the sample (and/or an output layer representation of the sample) to generate a plurality of perturbed hidden layer representations (and/or a plurality of perturbed output layer representations), inputting each respective perturbed hidden layer representation (and/or output layer representation) to the machine learning model to generate a further respective perturbed output, determining a subset of the plurality of perturbed hidden layer representations (and/or perturbed output layer representations) for which the further respective perturbed output differs from the final output, determining a respective smallest perturbation distance for the respective hidden layer (and/or output layer) based on the further respective distance of each respective perturbed hidden layer representation (and/or perturbed output layer representation) of the subset. Different samples may be selected and/or the process may be repeated for each selected sample. Additionally, such embodiments or aspects of the disclosed subject matter provide determining at least one vulnerability metric (e.g., a harmonic mean and/or a weighted summation) based on the smallest perturbation distance for the input layer and the respective smallest perturbation distance for each respective hidden layer (and/or the output layer) and retraining the machine learning model based on the at least one vulnerability metric. For example, retraining the machine learning model may include tracing features of at least one perturbed hidden layer representation (and/or at least one perturbed output layer representation) to the input layer, determining a volume of an input space based on tracing such features, and retraining the machine learning model based on a plurality of new samples in that volume of the input space. Such embodiments or aspects provide techniques and systems that improve detection of vulnerability to adversarial attacks. For example, such embodiments or aspects allow for probing not just the input space but also the hidden layer spaces (and/or output layer space) to find volumes in such spaces where vulnerabilities exist. Additionally, by probing the hidden layer (and/or output layer) spaces, the aforementioned embodiments or aspects provide techniques and systems that account for randomness and/or computational errors that can arise in hidden (and/or output) layers of deep machine learning models. Moreover, the aforementioned embodiments or aspects provide techniques and systems that enable retraining of the machine learning model based on the vulnerability metric(s), thereby improving the machine learning model and/or making the machine learning model more robust (e.g., less vulnerable to adversarial attack). For example, by retraining the machine learning model based on a plurality of new samples in a volume of the input space identified by tracing back from the hidden (and/or output) layers to the input layer, the machine learning model will be less vulnerable to adversarial attacks in that volume of the input space.

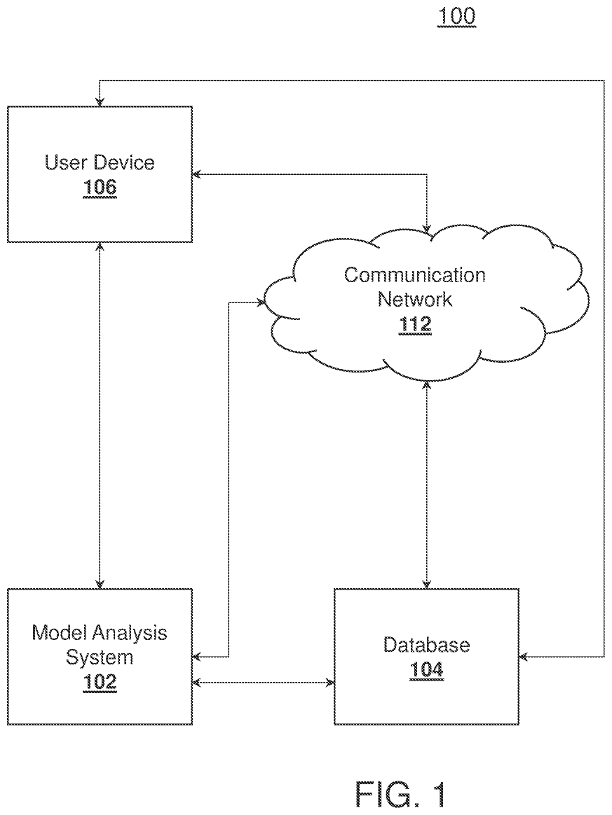

Referring now to FIG. 1, depicted is an example system 100 for multi-layer analysis and detection of vulnerability of machine learning models to adversarial attacks, according to some non-limiting embodiments or aspects. For example, system 100 may include model analysis system 102, database 104, user device 106, and/or communication network 112.

Model analysis system 102 may include one or more devices capable of receiving information from and/or communicating information to database 104 and/or user device 106 (e.g., directly via wired or wireless communication connection, indirectly via communication network 112, and/or the like). For example, model analysis system 102 may include a computing device, such as a server, a group of servers, a desktop computer, a portable computer, and/or other like devices. In some non-limiting embodiments or aspects, model analysis system 102 may be in communication with a data storage device (e.g., database 104), which may be local or remote to model analysis system 102. In some non-limiting embodiments or aspects, model analysis system 102 may be capable of receiving information from, storing information in, communicating information to, or searching information stored in the data storage device (e.g., database 104).

Database 104 may include one or more devices capable of receiving information from and/or communicating information to model analysis system 102 and/or user device 106 (e.g., directly via wired or wireless communication connection, indirectly via communication network 112, and/or the like). For example, database 104 may include a computing device, such as a server, a group of servers, and/or other like devices. In some non-limiting embodiments or aspects, database 104 may include a data storage device. In some non-limiting embodiments or aspects, database 104 may be capable of receiving information from, storing information in, communicating information to, or searching information stored in the data storage device. In some non-limiting embodiments or aspects, database 104 may be part of model analysis system 102 and/or part of the same system as model analysis system 102.

User device 106 may include one or more devices capable of receiving information from and/or communicating information to model analysis system 102 and/or database 104 (e.g., directly via wired or wireless communication connection, indirectly via communication network 112, and/or the like). For example, user device 106 may include a computing device, such as a mobile device, a portable computer, a desktop computer, and/or other like devices. Additionally or alternatively, each user device 106 may include a device capable of receiving information from and/or communicating information to other user devices 106 (e.g., directly via wired or wireless communication connection, indirectly via communication network 112, and/or the like). In some non-limiting embodiments or aspects, user device 106 may be part of model analysis system 102 and/or part of the same system as model analysis system 102.

Communication network 112 may include one or more wired and/or wireless networks. For example, communication network 112 may include a cellular network (e.g., a long-term evolution (LTE®) network, a third generation (3G) network, a fourth generation (4G) network, a fifth generation (5G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network (e.g., a private network associated with a transaction service provider), an ad hoc network, an intranet, the Internet, a fiber optic-based network, a cloud computing network, and/or the like, and/or a combination of these or other types of networks.

In some non-limiting embodiments or aspects, model analysis system 102 may select a sample of a plurality of samples of a dataset. For example, the dataset (e.g., including the plurality of data samples) may be received by model analysis system 102 (e.g., from database 104 and/or user device 106). Additionally or alternatively, model analysis system 102 may access the dataset (e.g., stored on database 104).

In some non-limiting embodiments or aspects, model analysis system 102 may randomly select the sample. In some non-limiting embodiments or aspects, model analysis system 102 may select the sample based on receiving input (e.g., from user device 106 and/or the like). For example, the input may include a selection (e.g., of the sample) by a user. Additionally or alternatively, the input may include at least one criterion (e.g., a set of criteria) for selection of the sample.

In some non-limiting embodiments or aspects, model analysis system 102 may input the sample to a machine learning model to generate at least one intermediate output and a final output. For example, the machine learning model may include a plurality of layers, such as an input layer, at least one hidden layer, and/or an output layer. Each intermediate output may include an output between successive layers of the plurality of layers. The final output may include an output of the output layer. In some non-limiting embodiments or aspects, upon inputting the sample to the input layer of the machine learning model, such input may be forward propagated through the machine learning model (e.g., from the input layer to the hidden layer(s) to the output layer) to generate the intermediate output(s) and the final output.

In some non-limiting embodiments or aspects, model analysis system 102 may perturb the sample to generate a plurality of perturbed samples. For example, each respective perturbed sample of the plurality of perturbed samples may have a respective distance from the sample. In some non-limiting embodiments or aspects, perturbing the sample may include determining (e.g., randomly selecting) a direction and a distance and generating the respective perturbed sample at that direction and distance from the sample. In some non-limiting embodiments or aspects, in an n-dimensional input space, a radius may define a ball around the sample, and the plurality of perturbed samples may include a plurality of predetermined and/or randomly determined points within that ball.

In some non-limiting embodiments or aspects, each respective distance may include a respective Euclidean distance (e.g., Euclidean norm, L2 norm, 2-norm, and/or the like.)

In some non-limiting embodiments or aspects, model analysis system 102 may input each respective perturbed sample to the machine learning model to generate a respective perturbed output. For example, upon inputting the respective perturbed sample to the input layer of the machine learning model, such input may be forward propagated through the machine learning model (e.g., from the input layer to the hidden layer(s) to the output layer) to generate the perturbed output.

In some non-limiting embodiments or aspects, model analysis system 102 may determine a subset of the plurality of perturbed samples for which the respective perturbed output differs from the final output. For example, the final output may be associated with a first classification and at least one of the perturbed outputs may be associated with a second classification different from the first classification. Any perturbed sample for which the respective perturbed output differs from the final output may be determined to be within the subset.

In some non-limiting embodiments or aspects, model analysis system 102 may determine a smallest perturbation distance for the input layer based on the respective distance of each respective perturbed sample of the subset. For example, whichever perturbed sample of the subset has the smallest (e.g., least) respective distance from the sample may be determined to be the perturbed sample having the smallest perturbation distance.

In some non-limiting embodiments or aspects, for each respective hidden layer of the at least one hidden layer, model analysis system 102 may perturb a respective hidden layer representation of the sample to generate a plurality of perturbed hidden layer representations. For example, the hidden layer representation of the sample may be a result of forward propagating the sample from the input layer to the respective hidden layer. In some non-limiting embodiments or aspects, the hidden layer representation of the sample may include a feature vector representing the sample in a feature space of the respective hidden layer. In some non-limiting embodiments or aspects, each respective perturbed hidden layer representation may have a respective distance from the respective hidden layer representation of the sample. In some non-limiting embodiments or aspects, perturbing the hidden layer representation may include determining (e.g., randomly selecting) a direction and a distance and generating the respective perturbed hidden layer representation at that direction and distance from the hidden layer representation. In some non-limiting embodiments or aspects, in an n-dimensional hidden layer space (e.g., feature space of the respective hidden layer), which may be a different number of dimensions (e.g., a smaller number of dimensions, a larger number of dimensions, and/or the like) than the input space, a radius may define a ball around the hidden layer representation, and the plurality of perturbed hidden layer representations may include a plurality of predetermined and/or randomly determined points within that ball.

In some non-limiting embodiments or aspects, for each respective hidden layer of the at least one hidden layer, model analysis system 102 may input each respective perturbed hidden layer representation to the machine learning model to generate a further respective perturbed output. For example, upon inputting the respective perturbed hidden layer representation to the respective hidden layer of the machine learning model, such input may be forward propagated through the machine learning model (e.g., from the respective hidden layer to subsequent hidden layer(s), if any, and/or to the output layer) to generate the further respective perturbed output.

In some non-limiting embodiments or aspects, for each respective hidden layer of the at least one hidden layer, model analysis system 102 may determine a subset of the plurality of perturbed hidden layer representations for which the further respective perturbed output differs from the final output. For example, the final output may be associated with a first classification and at least one of the further respective perturbed outputs may be associated with a second classification different from the first classification. Any perturbed hidden layer representation for which the further respective perturbed output differs from the final output may be determined to be within the subset.

In some non-limiting embodiments or aspects, for each respective hidden layer of the at least one hidden layer, model analysis system 102 may determine a respective smallest perturbation distance for the respective hidden layer based on the respective distance of each respective perturbed hidden layer representation of the subset of the plurality of perturbed hidden layer representations. For example, whichever perturbed hidden layer representation of the subset has the smallest (e.g., least) respective distance from the hidden layer representation may be determined to be the perturbed hidden layer representation having the smallest perturbation distance for the respective hidden layer.

In some non-limiting embodiments or aspects, the aforementioned techniques described for each hidden layer may be repeated for the output layer, as described herein.

In some non-limiting embodiments or aspects, the aforementioned techniques described for the input layer, each hidden layer, and/or the output layer may be repeated for additional samples (e.g., all samples, a subset of samples, a randomly selected subset of samples, and/or the like) of the dataset, as described herein.

In some non-limiting embodiments or aspects, model analysis system 102 may determine at least one vulnerability metric based on the smallest perturbation distance for the input layer and the respective smallest perturbation distance for each respective hidden layer (and/or the smaller perturbation distance for the output layer). For example, the vulnerability metric(s) may include at least one of a harmonic mean or a weighted summation, as described herein.

In some non-limiting embodiments or aspects, model analysis system 102 may retrain the machine learning model based on the vulnerability metric(s). For example, retraining the machine learning model may include tracing features of at least one perturbed hidden layer representation of the plurality of perturbed hidden layer representations to the input layer, determining a volume of an input space (e.g., n-dimensional input space) based on tracing the features of the perturbed hidden layer representation(s), and/or retraining the machine learning model based on a plurality of new samples (e.g., stored in, received from, and/or retrieved from database 104) in that volume of the input space.

The number and arrangement of systems and devices shown in FIG. 1 are provided as an example. There may be additional systems and/or devices, fewer systems and/or devices, different systems and/or devices, and/or differently arranged systems and/or devices than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g., one or more systems) or a set of devices (e.g., one or more devices) of system 100 may perform one or more functions described as being performed by another set of systems or another set of devices of system 100.

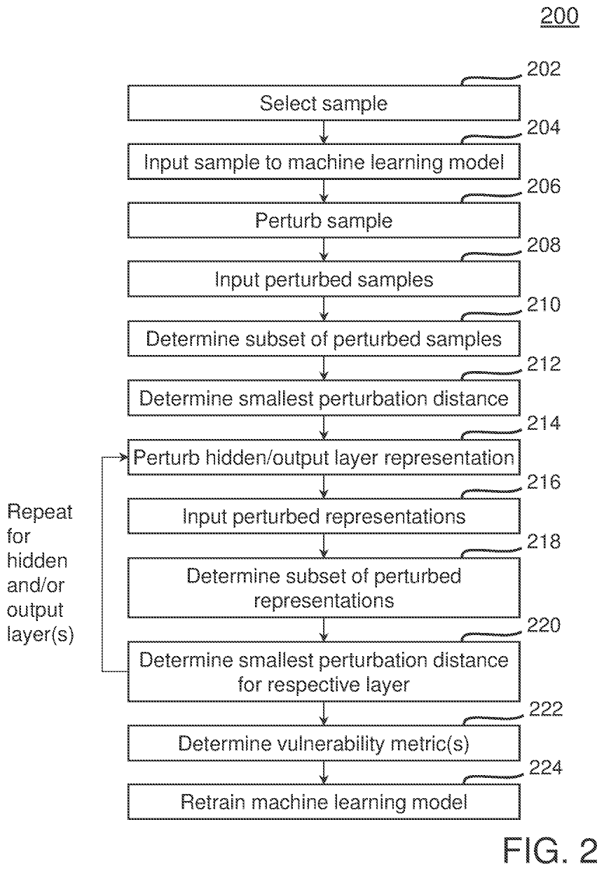

Referring now to FIG. 2, shown is a process 200 for multi-layer analysis and detection of vulnerability of machine learning models to adversarial attacks, according to some non-limiting embodiments or aspects. The steps shown in FIG. 2 are for example purposes only. It will be appreciated that additional, fewer, different, and/or a different order of steps may be used in non-limiting embodiments or aspects. In some non-limiting embodiments or aspects, one or more of the steps of process 200 may be performed (e.g., completely, partially, and/or the like) by model analysis system 102 (e.g., one or more devices of model analysis system 102). In some non-limiting embodiments or aspects, one or more of the steps of process 200 may be performed (e.g., completely, partially, and/or the like) by another system, another device, another group of systems, or another group of devices, separate from or including model analysis system 102, such as database 104 and/or user device 106.

As shown in FIG. 2, at step 202, process 200 may include selecting a sample. For example, model analysis system 102 may select a sample of a plurality of samples of a dataset.

In some non-limiting embodiments or aspects, the dataset (e.g., including the plurality of data samples) may be received by model analysis system 102 (e.g., from database 104 and/or user device 106). Additionally or alternatively, model analysis system 102 may access the dataset (e.g., stored on database 104).

In some non-limiting embodiments or aspects, model analysis system 102 may randomly select the sample.

In some non-limiting embodiments or aspects, model analysis system 102 may select the sample based on receiving input (e.g., from user device 106 and/or the like). For example, the input may include a selection (e.g., of the sample) by a user. Additionally or alternatively, the input may include at least one criterion (e.g., a set of criteria) for selection of the sample.

As shown in FIG. 2, at step 204, process 200 may include inputting the sample to a machine learning model. For example, model analysis system 102 may input the sample to a machine learning model to generate at least one intermediate output and a final output.

In some non-limiting embodiments or aspects, the machine learning model may include a plurality of layers, such as an input layer, at least one hidden layer, and/or an output layer. Each intermediate output may include an output between successive layers of the plurality of layers. The final output may include an output of the output layer.

In some non-limiting embodiments or aspects, upon inputting the sample to the input layer of the machine learning model, such input may be forward propagated through the machine learning model (e.g., from the input layer to the hidden layer(s) to the output layer) to generate the intermediate output(s) and the final output.

As shown in FIG. 2, at step 206, process 200 may include perturbing the sample. For example, model analysis system 102 may perturb the sample to generate a plurality of perturbed samples. In some non-limiting embodiments or aspects, each respective perturbed sample of the plurality of perturbed samples may have a respective distance from the sample. In some non-limiting embodiments or aspects, each respective distance may include a respective Euclidean distance (e.g., Euclidean norm, L2 norm, 2-norm, and/or the like.)

In some non-limiting embodiments or aspects, perturbing the sample may include determining (e.g., randomly selecting) a direction and a distance and generating the respective perturbed sample at that direction and distance from the sample.

In some non-limiting embodiments or aspects, in an n-dimensional input space, a radius may define a ball around the sample, and the plurality of perturbed samples may include a plurality of predetermined and/or randomly determined points within that ball.

As shown in FIG. 2, at step 208, process 200 may include inputting the perturbed samples to the machine learning model. For example, model analysis system 102 may input each respective perturbed sample to the machine learning model to generate a respective perturbed output.

In some non-limiting embodiments or aspects, upon inputting the respective perturbed sample to the input layer of the machine learning model, such input may be forward propagated through the machine learning model (e.g., from the input layer to the hidden layer(s) to the output layer) to generate the perturbed output.

As shown in FIG. 2, at step 210, process 200 may include determining a subset of the perturbed samples. For example, model analysis system 102 may determine a subset of the plurality of perturbed samples for which the respective perturbed output differs from the final output.

In some non-limiting embodiments or aspects, the final output may be associated with a first classification and at least one of the perturbed outputs may be associated with a second classification different from the first classification. Any perturbed sample for which the respective perturbed output differs from the final output may be determined to be within the subset.

As shown in FIG. 2, at step 212, process 200 may include determining a smallest perturbation distance. For example, model analysis system 102 may determine a smallest perturbation distance for the input layer based on the respective distance of each respective perturbed sample of the subset.

In some non-limiting embodiments or aspects, whichever perturbed sample of the subset has the smallest (e.g., least) respective distance from the sample may be determined to be the perturbed sample having the smallest perturbation distance.

As shown in FIG. 2, at step 214, process 200 may include perturbing a hidden layer representation (and/or an output layer representation) of the sample. For example, model analysis system 102 may perturb a respective hidden (or output) layer representation of the sample to generate a plurality of perturbed hidden (or output) layer representations.

In some non-limiting embodiments or aspects, the hidden (or output) layer representation of the sample may be a result of forward propagating the sample from the input layer to the respective hidden (or output) layer. In some non-limiting embodiments or aspects, the hidden (or output) layer representation of the sample may include a feature vector representing the sample in a feature space of the respective hidden (or output) layer.

In some non-limiting embodiments or aspects, each respective perturbed hidden (or output) layer representation may have a respective distance from the respective hidden (or output) layer representation of the sample. For example, each such distance may include a Euclidean distance (e.g., Euclidean norm, L2 norm, 2-norm, and/or the like).

In some non-limiting embodiments or aspects, perturbing the hidden (or output) layer representation may include determining (e.g., randomly selecting) a direction and a distance and generating the respective perturbed hidden (or output) layer representation at that direction and distance from the hidden (or output) layer representation. In some non-limiting embodiments or aspects, in an n-dimensional hidden (or output) layer space (e.g., feature space of the respective hidden or output layer), which may be a different number of dimensions (e.g., a smaller number of dimensions, a larger number of dimensions, and/or the like) than the input space, a radius may define a ball around the hidden (or output) layer representation, and the plurality of perturbed hidden (or output) layer representations may include a plurality of predetermined and/or randomly determined points within that ball.

As shown in FIG. 2, at step 216, process 200 may include inputting the perturbed hidden (or output) layer representations to the machine learning model. For example, model analysis system 102 may input each respective perturbed hidden (or output) layer representation to the machine learning model to generate a further respective perturbed output.

In some non-limiting embodiments or aspects, upon inputting the respective perturbed hidden (or output) layer representation to the respective hidden (or output) layer of the machine learning model, such input may be forward propagated through the machine learning model (e.g., from the respective hidden layer to subsequent hidden layer(s), if any, and/or to the output layer) to generate the further respective perturbed output.

As shown in FIG. 2, at step 218, process 200 may include determining a subset of the perturbed hidden (or output) layer representations. For example, model analysis system 102 may determine a subset of the plurality of perturbed hidden (or output) layer representations for which the further respective perturbed output differs from the final output.

In some non-limiting embodiments or aspects, the final output may be associated with a first classification and at least one of the further respective perturbed outputs may be associated with a second classification different from the first classification. Any perturbed hidden (or output) layer representation for which the further respective perturbed output differs from the final output may be determined to be within the subset.

As shown in FIG. 2, at step 220, process 200 may include determining a smallest perturbation distance for the respective layer. For example, model analysis system 102 may determine a respective smallest perturbation distance for the respective hidden (or output) layer based on the respective distance of each respective perturbed hidden (or output) layer representation of the subset of the plurality of perturbed hidden (or output) layer representations.

In some non-limiting embodiments or aspects, whichever perturbed hidden (or output) layer representation of the subset has the smallest (e.g., least) respective distance from the hidden (or output) layer representation may be determined to be the perturbed hidden (or output) layer representation having the smallest perturbation distance for the respective hidden (or output) layer.

In some non-limiting embodiments or aspects, steps 214-220 may be repeated for each hidden layer of the machine learning model. Additionally or alternatively, steps 214-220 may be repeated for the output layer of the machine learning model.

In some non-limiting embodiments or aspects, steps 202-220 may be repeated for each additional samples (e.g., all samples, a subset of samples, a randomly selected subset of samples, and/or the like) of the dataset. For example, model analysis system 102 may repeat steps 202-220 until at least a predetermined proportion of samples of the dataset are selected.

As shown in FIG. 2, at step 222, process 200 may include determining at least one vulnerability metric. For example, model analysis system 102 may determine at least one vulnerability metric based on the smallest perturbation distance for the input layer and the respective smallest perturbation distance for each respective hidden layer (and/or the smaller perturbation distance for the output layer).

In some non-limiting embodiments or aspects, the vulnerability metric(s) may include at least one of a harmonic mean or a weighted summation, as described herein.

As shown in FIG. 2, at step 224, process 200 may include retraining the machine learning model. For example, model analysis system 102 may retrain the machine learning model based on the vulnerability metric(s). For example, if the vulnerability metrics indicate that the machine learning model is vulnerable to adversarial attacks, the machine learning model may be retrained.

In some non-limiting embodiments or aspects, retraining the machine learning model may include tracing features of at least one perturbed hidden layer representation of the plurality of perturbed hidden layer representations to the input layer, determining a volume of an input space (e.g., n-dimensional input space) based on tracing the features of the perturbed hidden layer representation(s), and/or retraining the machine learning model based on a plurality of new samples (e.g., stored in, received from, and/or retrieved from database 104) in that volume of the input space.

In some non-limiting embodiments or aspects, retraining the machine learning model based on the plurality of new samples may include model analysis system 102 inputting each respective new sample to the machine learning model to generate a respective predicted output (e.g., an output of the output layer and/or the like). The respective predicted output may be compared to a known classification (e.g., a label and/or the like) associated with the respective new sample, and/or a loss may be determined based on the respective predicted output and the known classification (e.g., calculated based on a loss function, the respective predicted output, and the known classification). In some embodiments, model analysis system 102 may update (e.g., adjust) the parameters (e.g., weights, connection values, and/or the like) of the machine learning model based on the loss (e.g., using back propagation, gradient calculations, and/or the like).

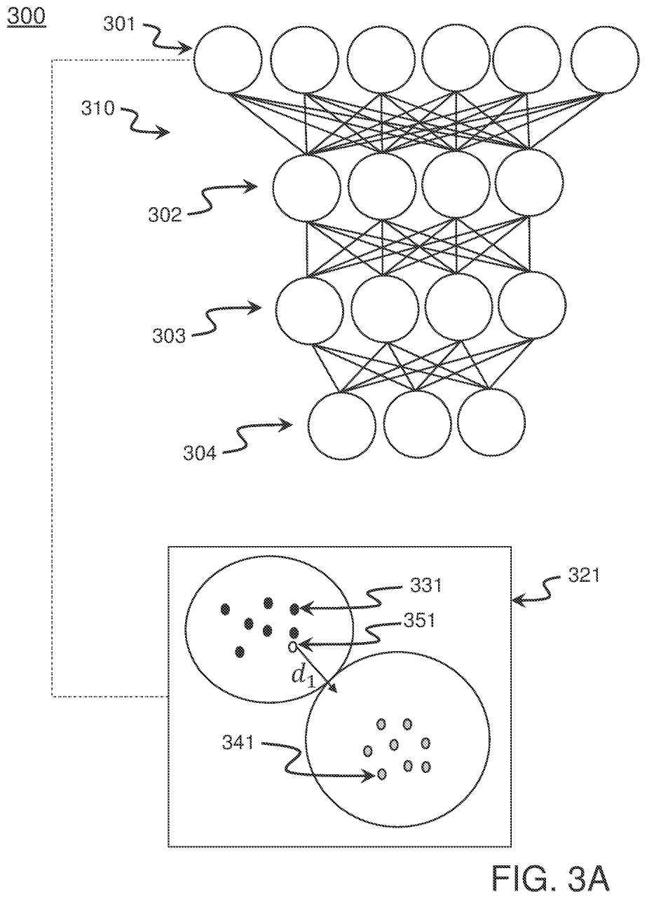

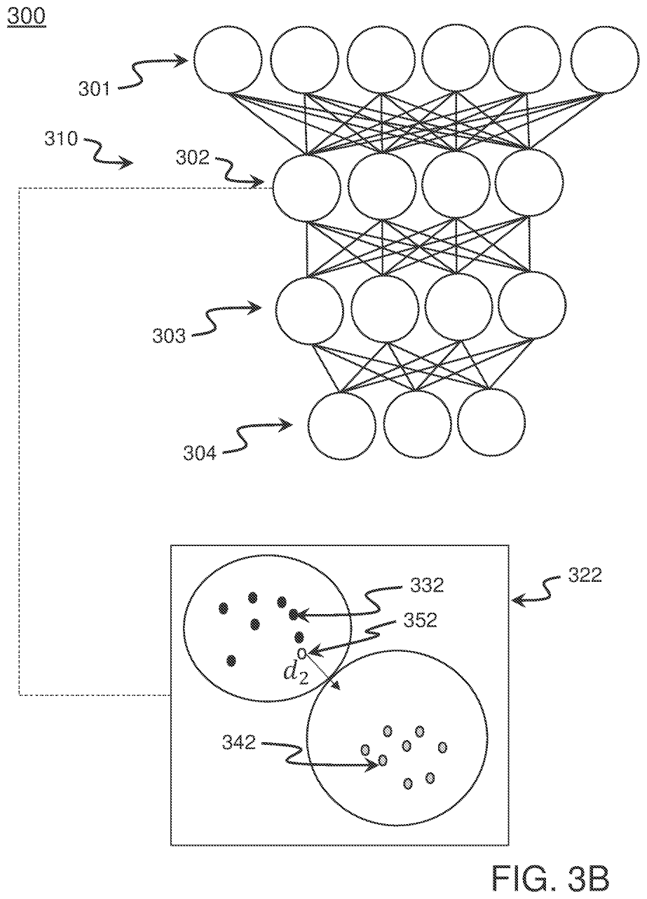

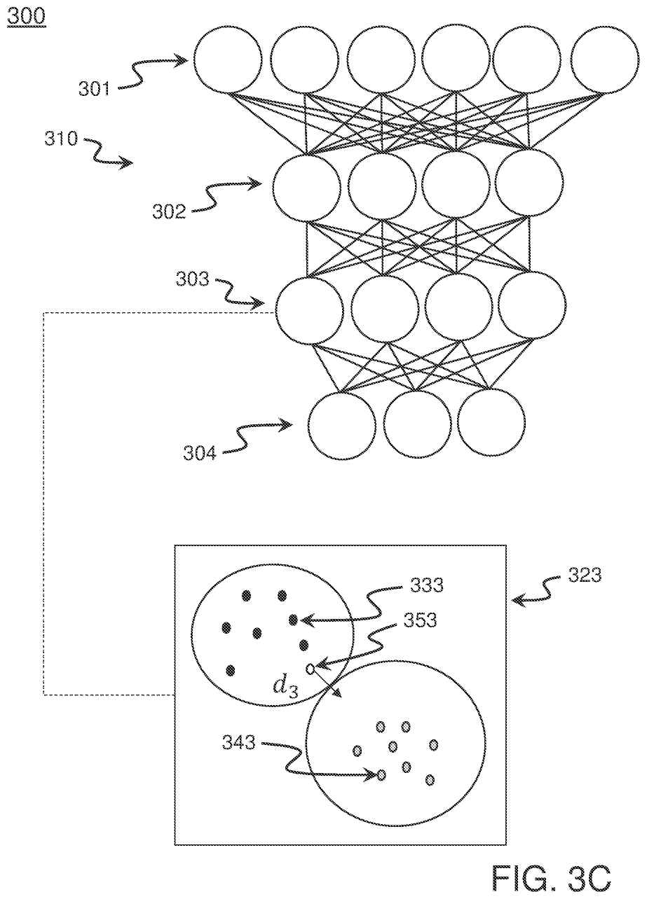

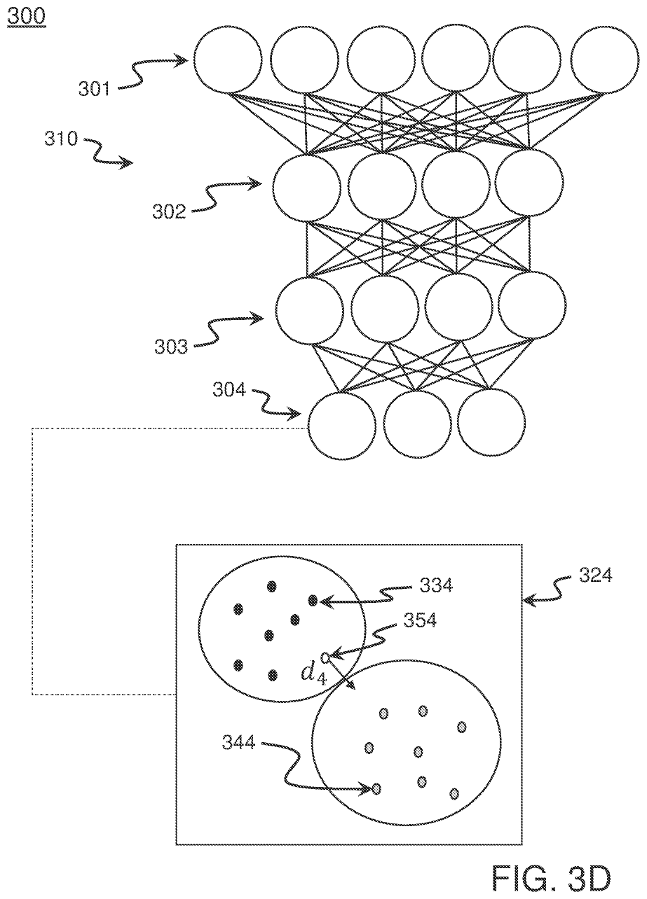

Referring now to FIGS. 3A-3D, shown are diagrams of an example implementation 300 of a process for multi-layer analysis and detection of vulnerability of machine learning models to adversarial attacks, according to some non-limiting embodiments or aspects. In some non-limiting embodiments or aspects, one or more of the steps of implementation 300 may be performed (e.g., completely, partially, and/or the like) by model analysis system 102 (e.g., one or more devices of model analysis system 102). In some non-limiting embodiments or aspects, one or more of the steps of implementation 300 may be performed (e.g., completely, partially, and/or the like) by another system, another device, another group of systems, or another group of devices, separate from or including model analysis system 102, such as database 104 and/or user device 106. The number and arrangement of layers, nodes, connections, and samples shown in FIGS. 3A-3D are for example purposes only. It will be appreciated that additional, fewer, different, and/or differently arranged layers, nodes, connections, and/or samples steps may be used in non-limiting embodiments or aspects. The steps shown in FIGS. 3A-3D are for example purposes only. It will be appreciated that additional, fewer, different, and/or a different order of steps may be used in non-limiting embodiments or aspects.

As shown in FIGS. 3A-3D, machine learning model 310 may include input layer 301, first hidden layer 302, second hidden layer 303, and output layer 304. Each layer may include a plurality of nodes. For example, each node may be represented by a circle. For the purpose of illustration, input layer 301 may include six nodes (e.g., six circles), first hidden layer 302 may include four nodes (e.g., four circles), second hidden layer 303 may include four nodes (e.g., four circles), and/or output layer 304 may include 3 nodes (e.g., three circles). Each node of a given layer may be connected to at least some (e.g., all) nodes of a next layer (e.g., nodes of input layer 301 may be connected to nodes of first hidden layer 302, nodes of first hidden layer 302 may be connected to nodes of second hidden layer 303, nodes of second hidden layer 303 may be connected to nodes of output layer 304). For example, each connection may be represented by a line connecting two circles. In some non-limiting embodiments or aspects, the dimensions of a space (e.g., input space 321, first hidden layer feature space 322, second hidden layer feature space 323, output layer feature space 324, and/or the like) for each layer may be equal to the number of nodes of that layer.

As shown in FIG. 3A, input space 321 may be associated with input layer 301. For example, input space 321 may include a first plurality of samples 331 for which machine learning model 310 generated a final output associated with a first classification and a second plurality of samples 341 for which machine learning model 310 generated a final output associated with a second classification.

In some non-limiting embodiments or aspects, selected sample 351 may be selected (e.g., by model analysis system 102 and/or the like), as described herein. For example, selected sample 351 may be one of the first plurality of samples 331.

In some non-limiting embodiments or aspects, a smallest perturbation distance di may be determined (e.g., by model analysis system 102 and/or the like) for input layer 301, as described herein.

As shown in FIG. 3B, first hidden layer feature space 322 may be associated with first hidden layer 302. For example, first hidden layer feature space 322 may include a first plurality of hidden layer representations 332 associated with the first plurality of samples 331 and a second plurality of hidden layer representations 342 associated with the second plurality of samples 341. For example, selected hidden layer representation 352 may be associated with selected sample 351.

In some non-limiting embodiments or aspects, a smallest perturbation distance d₂ may be determined (e.g., by model analysis system 102 and/or the like) for first hidden layer 302, as described herein.

As shown in FIG. 3C, second hidden layer feature space 323 may be associated with second hidden layer 303. For example, second hidden layer feature space 323 may include a first plurality of hidden layer representations 333 associated with the first plurality of samples 331 and a second plurality of hidden layer representations 343 associated with the second plurality of samples 341. For example, selected hidden layer representation 353 may be associated with selected sample 351.

In some non-limiting embodiments or aspects, a smallest perturbation distance d₃ may be determined (e.g., by model analysis system 102 and/or the like) for second hidden layer 303, as described herein.

As shown in FIG. 3D, output layer feature space 324 may be associated with output layer 304. For example, output layer feature space 324 may include a first plurality of output layer representations 334 associated with the first plurality of samples 331 and a second plurality of output layer representations 344 associated with the second plurality of samples 341. For example, selected output layer representation 354 may be associated with selected sample 351.

In some non-limiting embodiments or aspects, a smallest perturbation distance d₄ may be determined (e.g., by model analysis system 102 and/or the like) for output layer 304, as described herein.

In some non-limiting embodiments or aspects, at least one vulnerability metric may be determined based on the distances d₁-d₄. For example, the vulnerability metric(s) may include at least one of a harmonic mean or a weighted summation.

For the purpose of illustration, the harmonic mean (dₕ) may be calculated based on the following equation:

$${d}_{h} = {( \frac{{d}_{1}^{- 1} + {d}_{2}^{- 1} + {d}_{3}^{- 1} + {d}_{4}^{- 1}}{4} )}^{- 1}$$

For the purpose of illustration, the weighted summation (d_{w}) may be calculated based on the following equation:

$${d}_{w} = {α}_{1} {d}_{1} + {α}_{2} {d}_{2} + {α}_{3} {d}_{3} + {α}_{4} {d}_{4} ,$$

where α₁ is a first weight associated with input layer 301, α₂ is a second weight associated with first hidden layer 302, α₃ is a third weight associated with second hidden layer 303, and α₄ is a fourth weight associated with output layer 304.

In some non-limiting embodiments or aspects, the aforementioned weights may be determined based on a relative importance of each layer to the final output. For example, the relative weight of each layer may be determined based on iteratively dropping one layer at a time and comparing the accuracy of the machine learning model with such layer dropped to the accuracy of the machine learning model without such layer dropped and/or the accuracy of the machine learning model with a different layer dropped.

In some non-limiting embodiments or aspects, the aforementioned weights may be determined based on iteratively perturbing the weights of each layer an analyzing how the weighted summation (d_{w}) changes based on perturbing such weights.

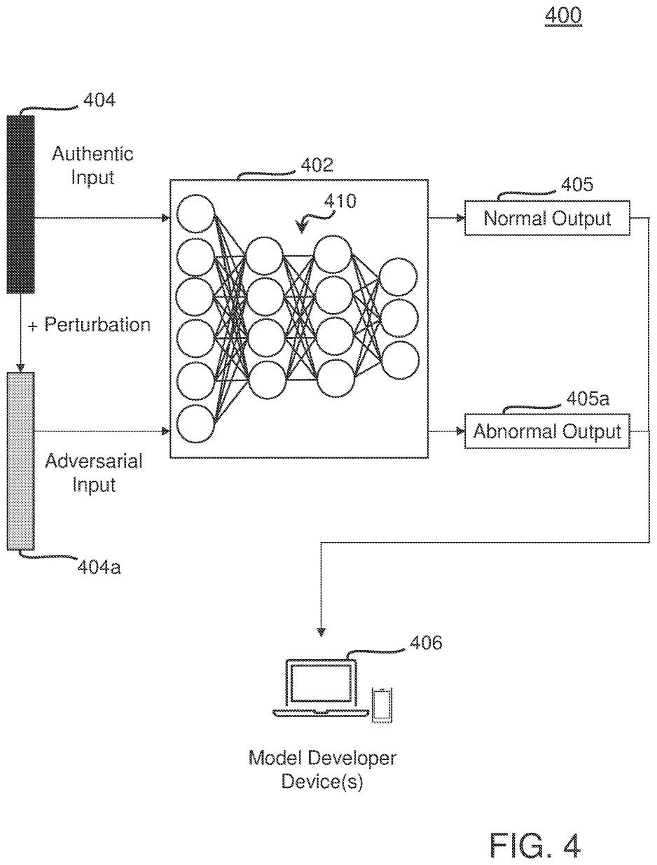

Referring now to FIG. 4, shown is a schematic diagram of an example implementation 400 of a system for multi-layer analysis and detection of vulnerability of machine learning models to adversarial attacks, according to some non-limiting embodiments or aspects. For example, implementation 400 may include model analysis system 402, authentic input 404, adversarial input 404a, normal output 405, abnormal output 405a, model developer devices 406, machine learning model 410, and/or the like. The number and arrangement of components shown in FIG. 4 are for example purposes only. It will be appreciated that additional, fewer, different, and/or differently arranged components may be used in non-limiting embodiments or aspects. In some non-limiting embodiments or aspects, model analysis system 402 may be the same as or similar to model analysis system 102. In some non-limiting embodiments or aspects, model developer devices 406 may be the same as or similar to user device 106. In some non-limiting embodiments or aspects, machine learning model 410 may be the same as or similar to machine learning model 310.

In some non-limiting embodiments or aspects, authentic input 404 may include one of a sample (e.g., selected sample in the input space), a hidden layer representation of the sample, or an output layer representation of the sample, as described herein. Additionally or alternatively, adversarial input 404a may include one of a perturbed sample, a perturbed hidden layer representation, or a perturbed output layer representation, as described herein.

In some non-limiting embodiments or aspects, adversarial input 404a may be the result of perturbing authentic input 404. For example, model analysis system 402 may perturb authentic input 404 to generate adversarial input 404a, as described herein.

In some non-limiting embodiments or aspects, model analysis system 402 may generate adversarial input 404a by adding a perturbation (e.g., a perturbation vector) to authentic input 404. For example, a perturbation vector may include a vector associated with a direction and a distance of perturbation. For the purpose of illustration, the perturbation vector may include a Euclidean vector with a number of dimensions equal to the number of dimensions associated with the respective layer of machine learning model 410, as described herein.

In some non-limiting embodiments or aspects, model analysis system 402 may input authentic input 404 to machine learning model 410 to generate normal output 405. For example, normal output 405 may be the same as or similar to the final output of machine learning model 410, as described herein. Additionally or alternatively, model analysis system 402 may input adversarial input 404a to machine learning model 410 to generate abnormal output 405a. For example, abnormal output 405a may be the same as or similar to a perturbed output, as described herein.

In some non-limiting embodiments or aspects, model analysis system 402 may determine a smallest perturbation distance for each layer of machine learning model 410, as described herein. For example, model analysis system 402 may determine at least one adversarial input 404a for which abnormal output 405a differs from normal output 405. Additionally or alternatively, model analysis system 402 may determine a smallest perturbation distance for the respective layer based on the distance from each such adversarial input 404a (e.g., for which abnormal output 405a differs from normal output 405) to the authentic input 404.

In some non-limiting embodiments or aspects, model analysis system 402 may determine at least one vulnerability metric based on the smallest perturbation distance for each respective layer (or for a subset of layers) of machine learning model 410, as described herein.

In some non-limiting embodiments or aspects, model analysis system 402 may retrain the machine learning model (e.g., based on the at least one vulnerability metric and/or the adversarial input 404a), as described herein.

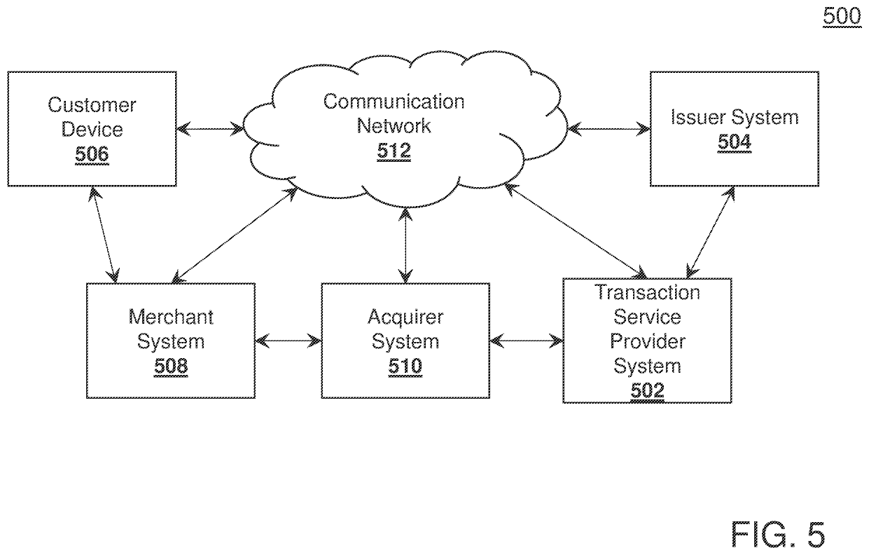

Referring now to FIG. 5, depicted is a diagram of a non-limiting embodiment or aspect of an exemplary environment 500 in which systems, products, and/or methods, as described herein, may be implemented. As shown in FIG. 5, environment 500 may include transaction service provider system 502, issuer system 504, customer device 506, merchant system 508, acquirer system 510, and communication network 512. In some non-limiting embodiments or aspects, each of model analysis system 102, database 104, and/or user device 106 of FIG. 1 and/or each of model analysis system 402 and/or user device 406 of FIG. 4 may be implemented by (e.g., part of) transaction service provider system 502. In some non-limiting embodiments or aspects, at least one of model analysis system 102, database 104, and/or user device 106 of FIG. 1 and/or at least one of model analysis system 402 and/or user device 406 of FIG. 4 may be implemented by (e.g., part of) another system, another device, another group of systems, or another group of devices, separate from or including transaction service provider system 502, such as issuer system 504, customer device 506, merchant system 508, acquirer system 510, and/or the like.

Transaction service provider system 502 may include one or more devices capable of receiving information from and/or communicating information to issuer system 504, customer device 506, merchant system 508, and/or acquirer system 510 via communication network 512. For example, transaction service provider system 502 may include a computing device, such as a server (e.g., a transaction processing server), a group of servers, and/or other like devices. In some non-limiting embodiments or aspects, transaction service provider system 502 may be associated with a transaction service provider as described herein. In some non-limiting embodiments or aspects, transaction service provider system 502 may be in communication with a data storage device, which may be local or remote to transaction service provider system 502. In some non-limiting embodiments or aspects, transaction service provider system 502 may be capable of receiving information from, storing information in, communicating information to, or searching information stored in the data storage device.

Issuer system 504 may include one or more devices capable of receiving information and/or communicating information to transaction service provider system 502, customer device 506, merchant system 508, and/or acquirer system 510 via communication network 512. For example, issuer system 504 may include a computing device, such as a server, a group of servers, and/or other like devices. In some non-limiting embodiments or aspects, issuer system 504 may be associated with an issuer institution as described herein. For example, issuer system 504 may be associated with an issuer institution that issued a credit account, debit account, credit card, debit card, and/or the like to a user associated with customer device 506.

Customer device 506 may include one or more devices capable of receiving information from and/or communicating information to transaction service provider system 502, issuer system 504, merchant system 508, and/or acquirer system 510 via communication network 512. Additionally or alternatively, each customer device 506 may include a device capable of receiving information from and/or communicating information to other customer devices 506 via communication network 512, another network (e.g., an ad hoc network, a local network, a private network, a virtual private network, and/or the like), and/or any other suitable communication technique. For example, customer device 506 may include a client device and/or the like. In some non-limiting embodiments or aspects, customer device 506 may or may not be capable of receiving information (e.g., from merchant system 508 or from another customer device 506) via a short-range wireless communication connection (e.g., an NFC communication connection, an RFID communication connection, a Bluetooth® communication connection, a Zigbee® communication connection, and/or the like), and/or communicating information (e.g., to merchant system 508) via a short-range wireless communication connection.

Merchant system 508 may include one or more devices capable of receiving information from and/or communicating information to transaction service provider system 502, issuer system 504, customer device 506, and/or acquirer system 510 via communication network 512. Merchant system 508 may also include a device capable of receiving information from customer device 506 via communication network 512, a communication connection (e.g., an NFC communication connection, an RFID communication connection, a Bluetooth® communication connection, a Zigbee® communication connection, and/or the like) with customer device 506, and/or the like, and/or communicating information to customer device 506 via communication network 512, the communication connection, and/or the like. In some non-limiting embodiments or aspects, merchant system 508 may include a computing device, such as a server, a group of servers, a client device, a group of client devices, and/or other like devices. In some non-limiting embodiments or aspects, merchant system 508 may be associated with a merchant as described herein. In some non-limiting embodiments or aspects, merchant system 508 may include one or more client devices. For example, merchant system 508 may include a client device that allows a merchant to communicate information to transaction service provider system 502. In some non-limiting embodiments or aspects, merchant system 508 may include one or more devices, such as computers, computer systems, and/or peripheral devices capable of being used by a merchant to conduct a transaction with a user. For example, merchant system 508 may include a POS device and/or a POS system.

Acquirer system 510 may include one or more devices capable of receiving information from and/or communicating information to transaction service provider system 502, issuer system 504, customer device 506, and/or merchant system 508 via communication network 512. For example, acquirer system 510 may include a computing device, a server, a group of servers, and/or the like. In some non-limiting embodiments or aspects, acquirer system 510 may be associated with an acquirer as described herein.

Communication network 512 may include one or more wired and/or wireless networks. For example, communication network 512 may include a cellular network (e.g., a long-term evolution (LTE®) network, a third generation (3G) network, a fourth generation (4G) network, a fifth generation (5G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network (e.g., a private network associated with a transaction service provider), an ad hoc network, an intranet, the Internet, a fiber optic-based network, a cloud computing network, and/or the like, and/or a combination of these or other types of networks.

The number and arrangement of systems, devices, and/or networks shown in FIG. 5 are provided as an example. There may be additional systems, devices, and/or networks; fewer systems, devices, and/or networks; different systems, devices, and/or networks; and/or differently arranged systems, devices, and/or networks than those shown in FIG. 5. Furthermore, two or more systems or devices shown in FIG. 5 may be implemented within a single system or device, or a single system or device shown in FIG. 5 may be implemented as multiple, distributed systems or devices. Additionally or alternatively, a set of systems (e.g., one or more systems) or a set of devices (e.g., one or more devices) of environment 500 may perform one or more functions described as being performed by another set of systems or another set of devices of environment 500.

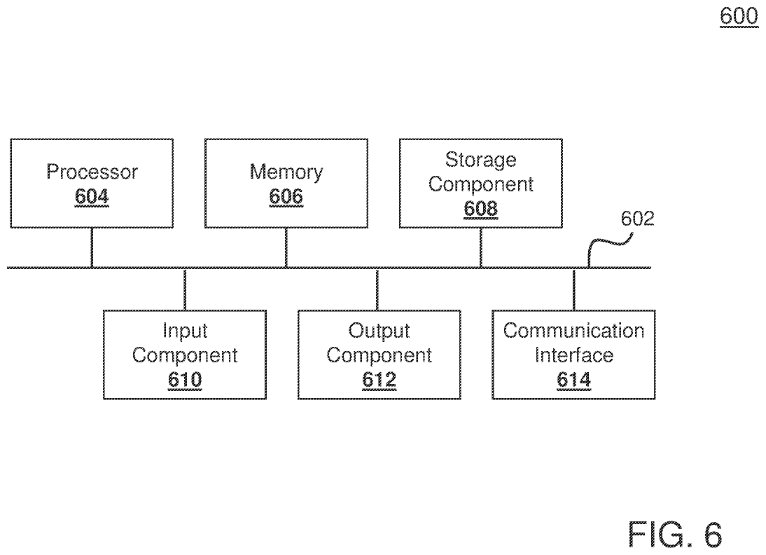

Referring now to FIG. 6, shown is a diagram of example components of a device 600 according to non-limiting embodiments or aspects. Device 600 may correspond to model analysis system 102, database 104, and/or user device 106 of FIG. 1, model analysis system 402 and/or user device 406 of FIG. 4, and/or transaction service provider system 502, issuer system 504, customer device 506, merchant system 508, acquirer system 510, and/or communication network 512 of FIG. 5, as examples. In some non-limiting embodiments or aspects, such systems or devices may include at least one device 600 and/or at least one component of device 600. The number and arrangement of components shown are provided as an example. In some non-limiting embodiments or aspects, device 600 may include additional components, fewer components, different components, or differently arranged components than those shown in FIG. 6. Additionally, or alternatively, a set of components (e.g., one or more components) of device 600 may perform one or more functions described as being performed by another set of components of device 600.

As shown in FIG. 6, device 600 may include a bus 602, a processor 604, memory 606, a storage component 608, an input component 610, an output component 612, and a communication interface 614. Bus 602 may include a component that permits communication among the components of device 600. In some non-limiting embodiments, processor 204 may be implemented in hardware, firmware, or a combination of hardware and software. For example, processor 604 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 606 may include random access memory (RAM), read only memory (ROM), and/or another type of dynamic or static storage device (e.g., flash memory, magnetic memory, optical memory, etc.) that stores information and/or instructions for use by processor 604.

With continued reference to FIG. 6, storage component 608 may store information and/or software related to the operation and use of device 600. For example, storage component 608 may include a hard disk (e.g., a magnetic disk, an optical disk, a magneto-optic disk, a solid state disk, etc.) and/or another type of computer-readable medium. Input component 610 may include a component that permits device 600 to receive information, such as via user input (e.g., a touch screen display, a keyboard, a keypad, a mouse, a button, a switch, a microphone, etc.). Additionally, or alternatively, input component 610 may include a sensor for sensing information (e.g., a global positioning system (GPS) component, an accelerometer, a gyroscope, an actuator, etc.). Output component 612 may include a component that provides output information from device 600 (e.g., a display, a speaker, one or more light-emitting diodes (LEDs), etc.). Communication interface 614 may include a transceiver-like component (e.g., a transceiver, a separate receiver and transmitter, etc.) that enables device 600 to communicate with other devices, such as via a wired connection, a wireless connection, or a combination of wired and wireless connections. Communication interface 614 may permit device 600 to receive information from another device and/or provide information to another device. For example, communication interface 614 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 600 may perform one or more processes described herein. Device 600 may perform these processes based on processor 604 executing software instructions stored by a computer-readable medium, such as memory 606 and/or storage component 608. A computer-readable medium may include any non-transitory memory device. A memory device includes memory space located inside of a single physical storage device or memory space spread across multiple physical storage devices. Software instructions may be read into memory 606 and/or storage component 608 from another computer-readable medium or from another device via communication interface 614. When executed, software instructions stored in memory 606 and/or storage component 608 may cause processor 604 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A computer-implemented method, comprising:
selecting, with at least one processor, a sample of a plurality of samples of a dataset;
inputting, with at least one processor, the sample to a machine learning model to generate at least one intermediate output and a final output, the machine learning model comprising a plurality of layers including an input layer, at least one hidden layer, and an output layer, each intermediate output of the at least one intermediate output comprising an output between successive layers of the plurality of layers, the final output comprising an output of the output layer;
perturbing, with at least one processor, the sample to generate a plurality of perturbed samples, each respective perturbed sample of the plurality of perturbed samples having a respective distance from the sample;
inputting, with at least one processor, each respective perturbed sample of the plurality of perturbed samples to the machine learning model to generate a respective perturbed output;
determining, with at least one processor, a subset of the plurality of perturbed samples for which the respective perturbed output differs from the final output;
determining, with at least one processor, a smallest perturbation distance for the input layer based on the respective distance of each respective perturbed sample of the subset of the plurality of perturbed samples;
for each respective hidden layer of the at least one hidden layer:
perturbing, with at least one processor, a respective hidden layer representation of the sample to generate a plurality of perturbed hidden layer representations, each respective perturbed hidden layer representation having a further respective distance from the respective hidden layer representation of the sample;
inputting, with at least one processor, each respective perturbed hidden layer representation to the machine learning model to generate a further respective perturbed output;
determining, with at least one processor, a subset of the plurality of perturbed hidden layer representations for which the further respective perturbed output differs from the final output; and
determining, with at least one processor, a respective smallest perturbation distance for the respective hidden layer based on the further respective distance of each respective perturbed hidden layer representation of the subset of the plurality of perturbed hidden layer representations;
determining, with at least one processor, at least one vulnerability metric based on the smallest perturbation distance for the input layer and the respective smallest perturbation distance for each respective hidden layer; and
retraining, with at least one processor, the machine learning model based on the at least one vulnerability metric.

2. The method of claim 1, wherein the sample comprises a selected sample, the method further comprising:
selecting, with at least one processor, a different sample of the plurality of samples of the dataset at the selected sample;
repeating the inputting of the selected sample to the machine learning model, the perturbing of the selected sample, the inputting of each respective perturbed sample to the machine learning model, the determining of the subset of the plurality of perturbed samples, the determining of the smallest perturbation distance for the input layer, the perturbing of the respective hidden layer representation of the selected sample for each respective hidden layer of the at least one hidden layer, the inputting of each respective perturbed hidden layer representation to the machine learning model for each respective hidden layer of the at least one hidden layer, the determining of the subset of the plurality of perturbed hidden layer representations for each respective hidden layer of the at least one hidden layer, the determining of the respective smallest perturbation distance for the respective hidden layer for each respective hidden layer of the at least one hidden layer, and the determining of the at least one vulnerability metric.

3. The method of claim 1, further comprising:
perturbing, with at least one processor, an output layer representation of the sample to generate a plurality of perturbed output layer representations, each respective perturbed output layer representation having a respective distance from the respective output layer representation of the sample;
inputting, with at least one processor, each respective perturbed output layer representation to the machine learning model to generate a respective perturbed output;
determining, with at least one processor, a subset of the plurality of perturbed output layer representations for which the respective perturbed output differs from the final output; and
determining, with at least one processor, a smallest perturbation distance for the output layer based on the respective distance of each respective perturbed output layer representation of the subset of the plurality of perturbed output layer representations,
wherein determining the at least one vulnerability metric comprises determining the at least one vulnerability metric based on the smallest perturbation distance for the input layer, the respective smallest perturbation distance for each respective hidden layer, and the smallest perturbation distance for the output layer.

4. The method of claim 1, wherein the at least one vulnerability metric comprises at least one of a harmonic mean or a weighted summation.

5. The method of claim 1, wherein each respective distance comprises a respective Euclidean distance.

6. The method of claim 1, wherein retraining the machine learning model based on the at least one vulnerability metric comprises:
tracing features of at least one perturbed hidden layer representation of the plurality of perturbed hidden layer representations to the input layer;
determining a volume of an input space based on tracing the features of the at least one perturbed hidden layer representation; and
retraining the machine learning model based on a plurality of new samples in the volume of the input space.

7. The method of claim 1, wherein selecting the sample comprises randomly selecting the sample from the plurality of samples.

8. A system, comprising:
at least one processor; and
at least one non-transitory computer-readable medium storing instructions that, when executed by the at least one processor, cause the at least one processor to:
select a sample of a plurality of samples of a dataset;
input the sample to a machine learning model to generate at least one intermediate output and a final output, the machine learning model comprising a plurality of layers including an input layer, at least one hidden layer, and an output layer, each intermediate output of the at least one intermediate output comprising an output between successive layers of the plurality of layers, the final output comprising an output of the output layer;
perturb the sample to generate a plurality of perturbed samples, each respective perturbed sample of the plurality of perturbed samples having a respective distance from the sample;
input each respective perturbed sample of the plurality of perturbed samples to the machine learning model to generate a respective perturbed output;
determine a subset of the plurality of perturbed samples for which the respective perturbed output differs from the final output;
determine a smallest perturbation distance for the input layer based on the respective distance of each respective perturbed sample of the subset of the plurality of perturbed samples;
for each respective hidden layer of the at least one hidden layer:
perturb a respective hidden layer representation of the sample to generate a plurality of perturbed hidden layer representations, each respective perturbed hidden layer representation having a further respective distance from the respective hidden layer representation of the sample;
input each respective perturbed hidden layer representation to the machine learning model to generate a further respective perturbed output;
determine a subset of the plurality of perturbed hidden layer representations for which the further respective perturbed output differs from the final output; and
determine a respective smallest perturbation distance for the respective hidden layer based on the further respective distance of each respective perturbed hidden layer representation of the subset of the plurality of perturbed hidden layer representations;
determine at least one vulnerability metric based on the smallest perturbation distance for the input layer and the respective smallest perturbation distance for each respective hidden layer; and
retrain the machine learning model based on the at least one vulnerability metric.

9. The system of claim 8, wherein the sample comprises a selected sample, and wherein the instructions, when executed by the at least one processor, further cause the at least one processor to:
select a different sample of the plurality of samples of the dataset at the selected sample;
repeat the inputting of the selected sample to the machine learning model, the perturbing of the selected sample, the inputting of each respective perturbed sample to the machine learning model, the determining of the subset of the plurality of perturbed samples, the determining of the smallest perturbation distance for the input layer, the perturbing of the respective hidden layer representation of the selected sample for each respective hidden layer of the at least one hidden layer, the inputting of each respective perturbed hidden layer representation to the machine learning model for each respective hidden layer of the at least one hidden layer, the determining of the subset of the plurality of perturbed hidden layer representations for each respective hidden layer of the at least one hidden layer, the determining of the respective smallest perturbation distance for the respective hidden layer for each respective hidden layer of the at least one hidden layer, and the determining of the at least one vulnerability metric.

10. The system of claim 8, wherein the instructions, when executed by the at least one processor, further cause the at least one processor to:
perturb an output layer representation of the sample to generate a plurality of perturbed output layer representations, each respective perturbed output layer representation having a respective distance from the respective output layer representation of the sample;
input each respective perturbed output layer representation to the machine learning model to generate a respective perturbed output;
determine a subset of the plurality of perturbed output layer representations for which the respective perturbed output differs from the final output; and
determine a smallest perturbation distance for the output layer based on the respective distance of each respective perturbed output layer representation of the subset of the plurality of perturbed output layer representations,
wherein determining the at least one vulnerability metric comprises determining the at least one vulnerability metric based on the smallest perturbation distance for the input layer, the respective smallest perturbation distance for each respective hidden layer, and the smallest perturbation distance for the output layer.

11. The system of claim 8, wherein the at least one vulnerability metric comprises at least one of a harmonic mean or a weighted summation.

12. The system of claim 8, wherein each respective distance comprises a respective Euclidean distance.

13. The system of claim 8, wherein retraining the machine learning model based on the at least one vulnerability metric comprises:
tracing features of at least one perturbed hidden layer representation of the plurality of perturbed hidden layer representations to the input layer;
determining a volume of an input space based on tracing the features of the at least one perturbed hidden layer representation; and
retraining the machine learning model based on a plurality of new samples in the volume of the input space.

14. The system of claim 8, wherein selecting the sample comprises randomly selecting the sample from the plurality of samples.

15. A computer program product comprising at least one non-transitory computer-readable medium including program instructions that, when executed by at least one processor, cause the at least one processor to:
select a sample of a plurality of samples of a dataset;
input the sample to a machine learning model to generate at least one intermediate output and a final output, the machine learning model comprising a plurality of layers including an input layer, at least one hidden layer, and an output layer, each intermediate output of the at least one intermediate output comprising an output between successive layers of the plurality of layers, the final output comprising an output of the output layer;
perturb the sample to generate a plurality of perturbed samples, each respective perturbed sample of the plurality of perturbed samples having a respective distance from the sample;
input each respective perturbed sample of the plurality of perturbed samples to the machine learning model to generate a respective perturbed output;
determine a subset of the plurality of perturbed samples for which the respective perturbed output differs from the final output;
determine a smallest perturbation distance for the input layer based on the respective distance of each respective perturbed sample of the subset of the plurality of perturbed samples;
for each respective hidden layer of the at least one hidden layer:
perturb a respective hidden layer representation of the sample to generate a plurality of perturbed hidden layer representations, each respective perturbed hidden layer representation having a further respective distance from the respective hidden layer representation of the sample;
input each respective perturbed hidden layer representation to the machine learning model to generate a further respective perturbed output;
determine a subset of the plurality of perturbed hidden layer representations for which the further respective perturbed output differs from the final output; and
determine a respective smallest perturbation distance for the respective hidden layer based on the further respective distance of each respective perturbed hidden layer representation of the subset of the plurality of perturbed hidden layer representations;
determine at least one vulnerability metric based on the smallest perturbation distance for the input layer and the respective smallest perturbation distance for each respective hidden layer; and
retrain the machine learning model based on the at least one vulnerability metric.

16. The computer program product of claim 15, wherein the sample comprises a selected sample, and wherein the instructions, when executed by the at least one processor, further cause the at least one processor to:
select a different sample of the plurality of samples of the dataset at the selected sample;
repeat the inputting of the selected sample to the machine learning model, the perturbing of the selected sample, the inputting of each respective perturbed sample to the machine learning model, the determining of the subset of the plurality of perturbed samples, the determining of the smallest perturbation distance for the input layer, the perturbing of the respective hidden layer representation of the selected sample for each respective hidden layer of the at least one hidden layer, the inputting of each respective perturbed hidden layer representation to the machine learning model for each respective hidden layer of the at least one hidden layer, the determining of the subset of the plurality of perturbed hidden layer representations for each respective hidden layer of the at least one hidden layer, the determining of the respective smallest perturbation distance for the respective hidden layer for each respective hidden layer of the at least one hidden layer, and the determining of the at least one vulnerability metric.

17. The computer program product of claim 15, wherein the instructions, when executed by the at least one processor, further cause the at least one processor to:
perturb an output layer representation of the sample to generate a plurality of perturbed output layer representations, each respective perturbed output layer representation having a respective distance from the respective output layer representation of the sample;
input each respective perturbed output layer representation to the machine learning model to generate a respective perturbed output;
determine a subset of the plurality of perturbed output layer representations for which the respective perturbed output differs from the final output; and
determine a smallest perturbation distance for the output layer based on the respective distance of each respective perturbed output layer representation of the subset of the plurality of perturbed output layer representations,
wherein determining the at least one vulnerability metric comprises determining the at least one vulnerability metric based on the smallest perturbation distance for the input layer, the respective smallest perturbation distance for each respective hidden layer, and the smallest perturbation distance for the output layer.

18. The computer program product of claim 15, wherein the at least one vulnerability metric comprises at least one of a harmonic mean or a weighted summation.

19. The computer program product of claim 15, wherein each respective distance comprises a respective Euclidean distance.

20. The computer program product of claim 15, wherein retraining the machine learning model based on the at least one vulnerability metric comprises:
tracing features of at least one perturbed hidden layer representation of the plurality of perturbed hidden layer representations to the input layer;
determining a volume of an input space based on tracing the features of the at least one perturbed hidden layer representation; and
retraining the machine learning model based on a plurality of new samples in the volume of the input space.
